(19) United States
(12) Patent Application Publication
(10) Pub. No.: US 2008/0006369 A1
(43) Pub. Date: Jan. 10, 2008

(54) Substrate bonding method

(75) Inventors: Seung Mo Lim, Suwon-si (KR); Hwa Sun Lee, Suwon-si (KR); Hye Jin Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/595,939

(22) Filed: Nov. 13, 2006

(30) Foreign Application Priority Data
Jul. 10, 2006 (KR) 10-2006-0064326

(51) Int. Cl. C09J 5/02

(52) U.S. Cl. 156/308.6

(57) ABSTRACT

A substrate bonding method using dry etching is disclosed. The substrate bonding method according to the exemplary embodiments of the present invention may notably reduce an amount of time required for bonding the substrates, and increase a manufacturing productivity.

### CROSS-REFERENCE TO RELATED APPLICATION

This application claims the benefit of Korean Patent Application No. 10-2006-0064326, filed on Jul. 10, 2006, in the Korean Intellectual Property Office, the disclosure of which is incorporated herein by reference.

### BACKGROUND OF THE INVENTION

1. Field of the Invention

The present invention relates to a method for bonding substrates, and more particularly, to a method for bonding silicon substrates with an improved productivity.

2. Description of Related Art

A silicon substrate is generally used to manufacture a variety of semiconductor devices. Specifically, various semiconductor devices are formed on the silicon substrate through a micro-manufacturing process. During the micro-manufacturing process, multiple silicon substrates are sometimes bonded together.

To bond multiple silicon substrates together, silicon direct bonding (SDB) is generally used. Referring to FIG. 1, the conventional SDB comprises steps of wet cleaning the surface of substrates, spin drying the cleaned surface, bringing the thus treated surface of each substrate to be bonded together to contact each other, and subjecting the substrates to heat treatment. In more detail, in step S1, a plurality of substrates to be bonded is provided. In step S3, a surface of each of the substrates is wet-cleaned. A RCA cleaning is generally used. The RCA cleaning is the industry standard for removing contaminants from wafers and widely known to the one skilled in the art. It has three major steps used sequentially: (1) organic clean step in which insoluble organic contaminants are removed with a 5:1:1 H₂O:H₂O₂:NH₄OH solution, (2) oxide strip step in which a thin silicon dioxide layer where metallic contaminants may have accumulated as a result of the organic clean step is removed using a diluted H₂O:HF solution, and (3) ionic clean step in which ionic and heavy metal atomic contaminants are removed using a solution of 6:1:1 H₂O:H₂O₂:HCl. The chemicals used for RCA cleaning are usually toxic.

In step S5, the wet-cleaned surface is dried by spin drying. In step S7, the substrates are arranged so that the thus treated surface of one substrate can be aligned and face the treated surface of another substrate, resulting in treated surfaces that are preliminarily bonded to each other by intermolecular attraction (i.e., van der Waals force).

In step S9, the bonded substrates are-subjected to heat treatment in a furnace at a temperature of about 1000° C., resulting in the two substrates being firmly bonded together

The conventional SDB has drawbacks.

First, it is a time-consuming procedure, which usually takes more than about 13 hours, causing a low manufacturing productivity in semiconductor-related manufacturing.

Second, during the heat treatment of the substrates at a very high temperature over about 1,000° C., gases are generated by the ions and the molecules which exist between the two surfaces. Such gases form voids at the interface of bonded surfaces, decreasing a bonding strength between the two surfaces. The poor bonding between the surfaces of the substrates may increase an error rate of semiconductor devices fabricated on such substrates and, consequently, the overall yield of the semiconductor device production decreases. Therefore, various proposals were made to remove voids. For example, forming a trench on a bonding surface of the substrates was proposed. However, the formation of a trench on the surface does not effectively remove voids.

Third, since heat treatment is performed at the temperature above about 1000° C. to firmly bond the substrates, any steps in the semiconductor manufacturing process, which should be conducted at a temperature lower than about 1000° C. are needed to be performed after bonding the substrates, which makes the semiconductor manufacturing process ineffective.

Moreover, the heat treatment at such a high temperature can cause a bending of substrates (both when the bonded substrates are of an identical material and thickness and when the bonded substrates are of different materials and thicknesses) or a deformation of a metal layer fabricated on the substrate.

When the SDB method is employed in a manufacturing process of an inkjet printer head, a hydrophobic coating of a head nozzle surface may be damaged by chemicals used in the RCA cleaning or the heat treatment. When the head nozzle is coated after the substrates are bonded in order to avoid the problem, an inside of the nozzle may be unnecessarily coated.

When substrates employed in a semiconductor manufacturing process contain closed pores in their inner structure, the closed pores expand during the heat treatment, causing the inner structure to be destroyed.

### SUMMARY OF THE INVENTION

The present invention provides a method for bonding multiple substrates, which can be performed in a shortened period of time and, thus, increases manufacturing productivity.

The present invention also provides a method for bonding multiple substrates, which does not comprise a heat treatment at a high temperature, and thereby produces bonded substrates free from voids and, thus, improves the bonding quality.

The present invention also provides a method for bonding substrates, which achieves a desirable bonding strength without a heat treatment at a high temperature, and thereby avoids drawbacks of the heat treating operation.

According to an aspect of the present invention, there is provided a method for bonding substrates, including: providing a plurality of substrates to be bonded; dry etching respective bonding surfaces of the substrates; exposing the respective bonding surfaces of the substrates to a substance containing an OH functional group; and bonding the substrates to each other by bringing the respective bonding surfaces of the substrates into contact with each other.

The dry etching may be performed using a reactive ion.

The substrate bonding method according to an exemplary embodiment of the present invention further includes subjecting the bonded substrates to a heat treatment. In this instance, the heat treatment is performed by annealing the bonded substrates at a temperature ranging from room temperature to 200° C. In an embodiment, the heat treatment may be carried out at a temperature ranging from room temperature to 100° C.

Also, the heat treatment may be performed in a hot plate where an electrothermal wire is arranged in a predetermined pattern. The substrate bonding method according to an exemplary embodiment of the present invention further includes drying the bonding surface after exposing it to the DI water.

According to another aspect of the present invention, there is provided a method for bonding substrates, including: providing a plurality of substrates to be bonded; generating a dangling bond on respective bonding surfaces of the substrates; bringing the respective bonding surfaces of the substrates into contact with a substance containing an OH functional group; and bonding the substrates to each other by bringing the respective bonding surfaces of the substrates into contact with each other. The contact of the respective bonding surfaces and the OH functional group-containing substrate may be carried out by exposing the bonding surfaces to DI water.

Also, the substrate bonding method further includes subjecting the bonded substrates to a heat treatment to improve a bonding strength between the substrates, and/or drying the bonding surfaces of the substrates.

### BRIEF DESCRIPTION OF THE DRAWINGS

The above and other aspects and advantages of exemplary embodiments of the present invention will become apparent and more readily appreciated from the following detailed description of certain exemplary embodiments of the invention, taken in conjunction with the accompanying drawings of which:

FIG. 1 is a flowchart illustrating silicon direct bonding (SDB) according to a conventional art;

FIG. 2 is a flowchart illustrating a substrate bonding method according to an exemplary embodiment of the present invention; and

FIGS. 3A through 3D are chemical structures sequentially illustrating a bond configuration of substrates in a substrate bonding method according to an exemplary embodiment of the present invention; and

FIG. 4 is a graph illustrating a result of an experiment of the conventional art and the present invention.

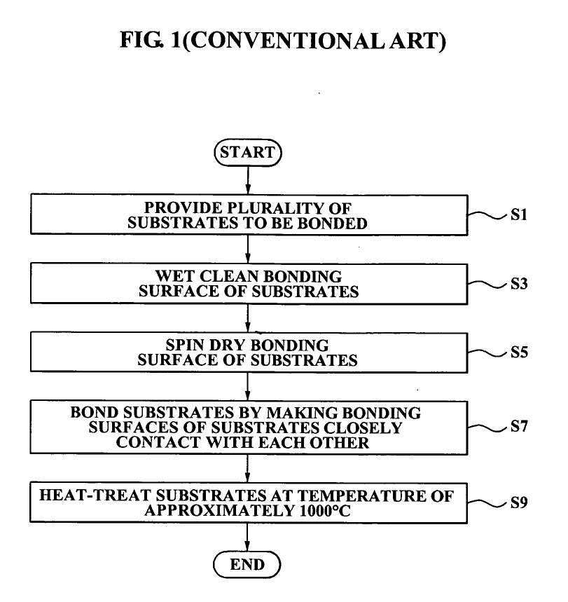

### DETAILED DESCRIPTION OF EXEMPLARY EMBODIMENTS OF THE INVENTION

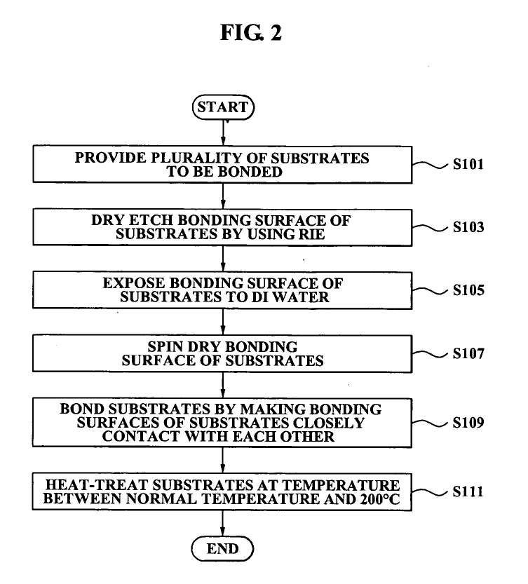

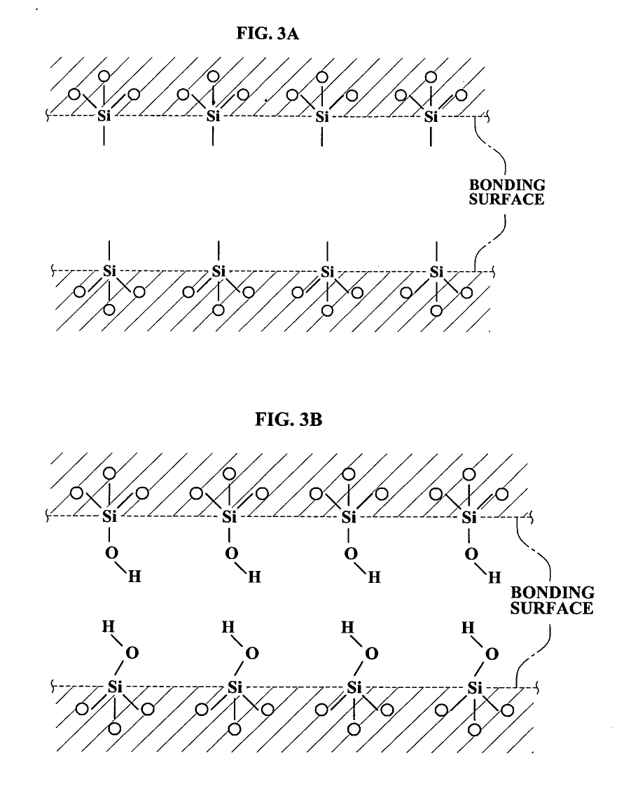

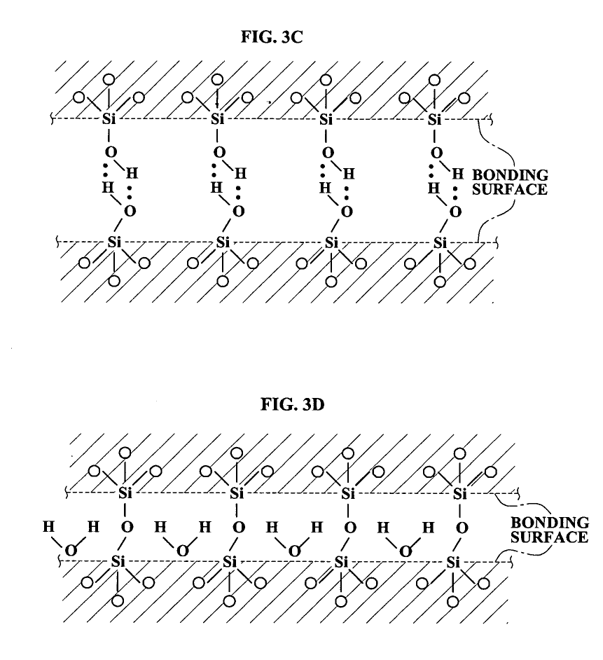

Referring to FIGS. 2 and 3A through 3D, the substrate bonding method according to an exemplary embodiment of the present invention is described.

FIG. 2 is a flowchart illustrating a substrate bonding method according to an exemplary embodiment of the present invention. FIGS. 3A through 3D are chemical structures sequentially illustrating a bonding configuration of substrates in a substrate bonding method according to an exemplary embodiment of the present invention.

In step S101, a plurality of substrates to be bonded is provided. In one embodiment, the substrates are silicon wafers.

While a method of bonding two substrates each having a respective bonding surface will be described in detail as an example below, it should be noted that the same process may apply to the cases where three substrates or more are bonded together.

In step S103, the bonding surface of the substrates is dry etched. Etching is generally used to create a pattern on a substrate. In the present invention, the etching is applied to generate a dangling bond to the bonding surface of the substrates.

The dry etching may be performed by various methods such as reactive ion etching (RIE), sputter etching, and vapor phase etching, which are well known in the art. An embodiment using reactive ion etching (RIE) is described herein. In RIE, the substrate is placed inside a reactor in which several gases are introduced. A plasma is struck in the gas mixture using a radio frequency (RF) power source, breaking the gas molecules into ions, which are accelerated towards, and react at, the bonding surface of the substrate.

As shown in FIG. 3A, the dry etching generates dangling bonds on the bonding surface of the substrates. The dry etching process can be completed in a greatly shorter period of time than the wet etching process.

In step S105, the bonding surface of the substrate is exposed to a substance containing an OH functional group. An example of such a substance includes deionized (DI) water. In this instance, as shown in FIG. 3B, the dangling bond, which is exposed on the bonding surface, and an OH radical are combined.

Exposing the bonding surface to the OH functional group-containing substance may be performed by a variety of methods. For example, the substrate or its part including the bonding surface may be dipped into the substance containing an OH-functional group. As an alternative, a solution of the OH functional group-containing substance may be sprayed onto the bonding surface of the substrate. In another alternative, the substrate may be placed in a chamber containing a vaporized form of such substance. This step is carried out for a period of time allowing the dangling bonds on the bonding surface may react with the OH group to form a Si—OH bond. In one embodiment, the bonding surface is exposed to the OH functional group-containing substance for about 5 minutes.

In step S107, the bonding surface which is exposed to the OH functional group-containing substance is spin dried for, for example, about 15 minutes. In step S109, the substrates are made to closely contact with each other to form a bond between the respective bonding surfaces of the substrates. As shown in FIG. 3C, molecules between the OH radicals are combined each other by intermolecular such as van der Waals force and hydrogen bonds.

In another embodiment, the bonding surface may be dried by, for example, spin drying, after it is exposed to the OH functional group-containing substance. (Step S107 in FIG. 2) It may be performed for about 15 minutes.

When a large number of dangling bonds are generated by dry etching and form Si—OH bonds during the exposure to a substance containing an OH functional group, the bonding strength of the bonded substrates may be improved. The dry etching (in case of RIE) may be carried out for several seconds to several tens of seconds.

To further improve the bonding strength, the bonded substrates may be subjected to heat treatment. (Step S111 in FIG. 2) It is stipulated, but is not a binding theory, that the heat treatment renders formation of Si—O—Si bonds and generates H₂O as shown in FIG. 3D.

The heat treatment may be performed at a temperature lower than about 200° C. In an alternative embodiment, the heat treatment may be performed at a temperature lower than about 100° C. for about 0.5-2 hours. This significantly shortens the time for bonding substrates, compared to the conventional method wherein the bonded substrates are subjected to a heat treatment at a temperature above about 1,000° C. for about 10 hours. The heat treating may be performed by annealing the substrates.

The substrate bonding method according to an exemplary embodiment of the present invention may achieve a desirable bonding strength, even when the heat treatment is performed at a significantly lower temperature than the temperature employed in the conventional art. Accordingly, the heat treatment may be performed using a hot plate where an electrothermal wire is arranged at predetermined intervals in a predetermined pattern.

Also, the substrate bonding method according to an exemplary embodiment of the present invention may achieve the desirable bonding strength by the intermolecular attraction, without subjecting the bonded substrates to a heat treatment.

In the substrate bonding method according to an exemplary embodiment of the present invention, a silicon dioxide film may be formed on at least one of the substrates. In this instance, the silicon dioxide film may be the bonding surface.

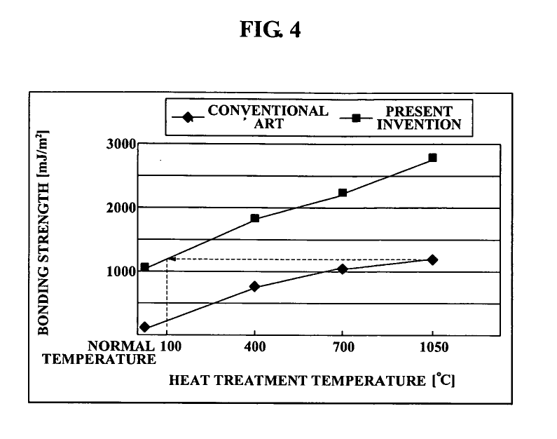

The bonding strengths of the bonded substrates, produced by the conventional method and an exemplary embodiment of the present invention were tested. The results are shown in FIG. 4. The bonded substrates according to the conventional method were prepared by wet etching respective bonding surfaces of substrates using RCA method for about 1 hour; spin drying the etched surfaces for about 15 minutes; placing and maintaining the respective surfaces of respective substrates together to be contacted to each other for about 10 minutes and subjecting the bonded substrates to a heat treatment to temperatures of 100° C., 400° C., 700° C. and 1,050° C., respectively, for each about 10 hours. The bonded substrates of one exemplary embodiment of the present application were prepared by dry etching respective bonding surfaces using RIE for about several seconds; exposing the etched bonding surfaces to a DI water for about 5 minutes; placing and maintaining the bonding surfaces of respective substrates together to be contacted to each other for about 10 minutes and subjecting the bonded substrates to a heat treatment to temperatures of 100° C., 400° C., 700° C. and 1,050° C., respectively, for each about 1 hour.

As shown in FIG. 4, the bonding strength of the bonded substrates prepared by a substrate bonding method according to an exemplary embodiment of the present invention is higher than the bonding strength of the bonded substrates of the conventional art.

Particularly, as shown in FIG. 4, the bonding strength after a heat treatment at a temperature of about 1050° C. according to the conventional art is similar to the bonding strength after the heat treating operation at room temperature according to an exemplary embodiment of the present invention, and about the same as the bonding strength after the heat treatment at a temperature of about 100° C. according to an exemplary embodiment of the present invention.

Accordingly, the heat treatment at a temperature above about 1,000° C. (i.e., heat treatment in a furnace) may be replaced with a treatment on a hot plate where an electrothermal wire is arranged in a predetermined pattern.

The increment in the bonding strength obtained by the method according to an exemplary embodiment of the present invention is greater than that obtained by the conventional art. Accordingly, when a very high bonding strength is needed, the method according to an exemplary embodiment of the present may be advantageously employed.

An example in which the substrate bonding method according to an exemplary embodiment of the present invention is applied to a silicon wafer has been described. However, the substrate bonding method according to an exemplary embodiment of the present invention may be applied to a method of bonding substrates consisting of a variety of silicon compounds.

According to the present invention, a heat treatment at a high temperature (e.g., above about 800° C.) can be omitted or replaced with a low temperature (e.g., about 100-200° C.) treatment. Therefore, the formation of voids may be prevented, and, consequently, the bonding quality may be improved. It also may broaden a selection of manufacturing processes for improving efficiency of the manufacturing process. Furthermore, defects caused from high temperature treatments, such as bending of substrates or deformation of metal layers on the substrate may be eliminated.

Also, a cost of production may be reduced, since a furnace of the high temperature may not be needed. For example, when bonded substrates are used in an inkjet printer head, the substrate bonding method according to the exemplary embodiments of the present invention may avoid damage to a hydrophobic coating of a head nozzle surface by chemicals which are used in the conventional wet cleaning or heat treatment. Also, the hydrophobic coating may be formed prior to bonding the substrates.

Also, when an inner structure of the substrates includes closed pores, the bonded substrates produced by the substrate bonding method according to the exemplary embodiments of the present invention may not experience an expansion of the pores, thereby maintaining intact internal structure.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method for bonding substrates, comprising:
providing a plurality of substrates to be bonded;
dry etching respective bonding surfaces of the substrates;
exposing the respective bonding surfaces of the substrates to a substance containing an OH functional group; and
bonding the substrates to each other by bringing the respective bonding surfaces of the substrates into contact with each other.

2. The method of claim 1, wherein the dry etching is performed by using a reactive ion.

3. The method of claim 1, further comprising:
performing a heat treatment on the bonded substrates.

4. The method of claim 3, wherein the heat treatment is performed at a temperature ranging from room temperature to 200° C.

5. The method of claim 3, wherein the heat treatment is performed on a hot plate having an electrothermal wire.

6. The method of claim 1, further comprising:
drying the bonding surfaces after the bonding surfaces are exposed to the OH functional group-containing substance.

7. The method of claim 1, wherein the substance containing an OH functional group is deionized water.

8. A method for bonding substrates, comprising:
providing a plurality of substrates to be bonded;
generating a dangling bond on respective bonding surfaces of the substrates;
bringing the respective bonding surfaces of the substrates contact into a substance containing an OH functional group; and bonding the substrates to each other by bringing the respective bonding surfaces of the substrates into contact with each other.

9. The method of claim 8, wherein the generation of a dangling bond is carried out by reactive ion etching, sputter etching, or vapor phase etching.

10. The method of claim 8, wherein the substance containing an OH functional group is deionized water.

11. The method of claim 10, wherein the contact between the respective bonding surfaces and the deionized water is carried out by dipping the substrates or a part thereof including the bonding surfaces into the deionized water.

12. The method of claim 8, further comprising:
subjecting the bonded substrates to a heat treatment.

13. The method of claim 8, further comprising:
drying the bonding surfaces of the substrates after contacting the bonding surface of the substrates with the substrate containing an OH functional group.
